(19) United States
(12) Patent Application Publication
(10) Pub. No.: US 2024/0257223 A1
(43) Pub. Date: Aug. 1, 2024

(54) SERVER AND METHOD FOR PROVIDING E-COMMERCE PLATFORM SERVICE RECOMMENDING ONLINE SHOP DESIGN

(71) Applicant: CONIALAB CO., LTD., Seoul (KR)

(72) Inventor: HYUN JUNG NA, Gyeonggi-do (KR)

(21) Appl. No.: 18/424,983

(22) Filed: Jan. 29, 2024

(30) Foreign Application Priority Data
Jan. 27, 2023 (KR) 10-2023-0010646

(51) Int. Cl. G06Q 30/0601

(52) U.S. Cl. CPC G06Q 30/0641

(57) ABSTRACT

An e-commerce platform server according to an embodiment includes a communication device, a memory that stores one or more instructions, and a processor that executes the one or more instructions stored in the memory, in which the processor, by executing the one or more instructions, registers a plurality of sellers including at least one top seller and at least one sub-seller in a seller DB in a hierarchy corresponding to a seller group, registers sales products of the top seller in a sales products DB, generates an online shop of each of the plurality of sellers, selects at least one seller among the plurality of sellers based on the hierarchy, determines at least one design based on a design of the online shop of the selected at least one seller, and recommends the determined at least one design to the seller.

### CROSS REFERENCE TO RELATED APPLICATION AND CLAIM OF PRIORITY

This application claims the benefit under 35 USC § 119 of Korean Patent Application No. 10-2023-0010646 filed on Jan. 27, 2023 in the Korean Intellectual Property Office, the entire disclosure of which is incorporated herein by reference for all purposes.

### BACKGROUND

### 1. Field

Embodiments of the present disclosure relate to a platform service technology for providing an e-commerce environment.

### 2. Description of Related Art

With the development of information and communication technology, online commerce, that is, e-commerce, which involves selling a product by building an online market, has developed. The initial form of online commerce was in the form in which a seller opened an online shopping mall (hereinafter referred to as shopping mall) directly, registered the product, and a visitor who accessed the shopping mall purchased the product, but with the advent of intermediary shopping malls that connect a seller and a purchaser emerged and grew into a large shopping malls (e.g., Auction, 11th Street, G Market, etc.) by providing convenient sales and purchasing services, which leads to explosive growth in an e-commerce market. Since then, this explosive growth has continued with the emergence of social commerce using social networks (e.g., Tmon, Wemakeprice) and various forms of e-commerce (e.g., Coupang) that provide innovative offline distribution and logistics services. These large-scale e-commerce platforms (e.g., large intermediary platforms, social commerce, etc.) are bringing large profits to a user, especially the seller.

Recently, a new type of e-commerce market is being actively formed using communication channels with fans of highly influential individuals with great influence on social network services (SNS) (e.g., Facebook, Instagram) and individual media services (e.g., influencer, celebrity, etc.), or through strong personal networks in communities where people with similar personal interests gather.

### SUMMARY

However, even if products are sold using the large-scale e-commerce platform described above, the seller should bear the initial costs for marketing (e.g., creation of product description pages, advertisement, etc.) and product distribution. And since the main source of income for these large-scale platforms is fees received from users, high fees may be charged to the users, especially the seller, depending on the size of the platform. In addition, competition for the lowest price with several sellers who have opened stores within the platform may lower a seller's margin rate, which may lead to a decrease in product quality and cause damage not only to purchasers and but also to platform services. Even if platform operators and a small number of sellers make a lot of profit in this process, this concentrated profit structure may stagnate or degrade the development of a platform ecosystem. In addition, the large-scale e-commerce platforms that focus on this relay of product sales may have limitations that make it difficult to make key members (e.g., influencer, community, etc.) of a newly formed e-commerce market through SNS, communities, etc. as new users on the e-commerce platform.

In addition, even if a solution is provided to allow the sellers to set up their own online shops in order to encourage the participation of many sellers in the e-commerce platform, it is difficult for the sellers to create a design suitable for the sales products from the beginning from the perspective of starting the sale, and even if the sellers pay a fee and apply a pre-made design or custom design to the online shop, it may be difficult to reflect the sales trend of rapidly changing products in real time. And, in order to compensate for this, a recommended design may be provided to a seller by borrowing another seller's design, but, providing his or her design to another seller who may be a potential competitor, from the perspective of the seller whose design is borrowed, may be negative for future sales. Therefore, the design that actively reflect the current trends of sellers recording high sales amount may be difficult to borrow.

Accordingly, various embodiments of the present disclosure are intended to provide the e-commerce platform service that allows a plurality of sellers to systematically sell products together and allows the plurality of sellers to share the design of the online shop with each other through the organizational characteristics of the plurality of sellers.

A platform server for providing an e-commerce platform service according to an embodiment of the present disclosure includes a communication device, a memory that stores one or more instructions, and a processor that executes the one or more instructions stored in the memory, and the processor, by executing the one or more instructions, registers a plurality of sellers including at least one top seller and at least one sub-seller subordinate to each of the at least one top seller in a seller DB in a hierarchy corresponding to a seller group, registers sales products of the top seller for each seller group in a sales products DB, generates an online shop of each of the plurality of sellers, the online shop including at least one of registered sales products of the top seller of the seller group to whom the plurality of sellers belong, selects at least one seller among the plurality of sellers based on the hierarchy, determines at least one design based on a design of the online shop of the selected at least one seller, and recommends the determined at least one design to the seller.

In addition, the hierarchy may be registered in the seller DB as a hierarchy consisting of the at least subordinate seller while being centered around the top seller.

In addition, the processor, by executing the one or more instructions, may select the at least one seller among a plurality of sellers of the seller group including the seller for whom the design is recommended, when selecting at least one seller among the plurality of sellers.

In addition, the processor, by executing the one or more instructions, may select the at least one seller based on similarity of content included in a configuration of the online shop when selecting at least one seller from the seller group of the seller for whom the design is recommended.

In addition, the similarity of the content may be determined based on information about a type of sales products, an image of the sales products, and a text description of the sales products.

In addition, the processor, by executing the one or more instructions, may select the at least one seller whose rank is higher than or equal to a designated rank based on information related to sales of the online shop when selecting at least one seller from the seller group of the seller for whom the design is recommended.

In addition, the information related to the sales of the online shop may include sales amount information, member subscription rate information, information on a length of time that a visitor stays in the online shop, information on a probability of revisit of the visitor, and purchase rate information of the visitor.

In addition, the processor, by executing the one or more instructions, may select the at least one seller among sub-sellers included in the seller group when selecting at least one seller from the seller group of the seller for whom the design is recommended.

In addition, the processor, by executing the one or more instructions, may register the top seller as a master seller in the seller DB, register sub-sellers subordinate to the top seller as manager sellers and general sellers subordinate to the manager seller in the seller DB, the manager seller being granted an authority to manage the general sellers, when registering the plurality of sellers in the hierarchy, and select the at least one seller among the general sellers when selecting at least one seller among the sub-sellers.

In addition, the processor, by executing the one or more instructions, may select the at least one seller from a seller group of another top seller who has registered products in the same category as sales products of the top seller to whom the seller, for whom the design is recommended, is subordinate, when selecting at least one seller among the plurality of sellers.

In addition, the processor, by executing the one or more instructions, may determine the design of the online shop of the selected at least one seller as the recommended at least one design when determining the at least one design.

In addition, a new design obtained by selectively combining parts of the design of the online shop of the selected at least one seller may be determined as the recommended at least one design, when determining the at least one design.

In addition, the processor, by executing the one or more instructions, may recommend the determined at least one design to the seller who requested generation of the online shop in a process of generating the online shop, when providing the determined at least one design to the seller.

In addition, the processor, by executing the one or more instructions, may recommend the determined at least one design to the seller in a process of providing consulting information based on history information on selling products through the generated online shop, when recommending the determined at least one design to the seller, and select the at least one seller whose sales amount is higher than that of the seller for whom the design is recommended among at least one of a seller group that includes the seller for whom the design is recommended and another seller group that sells products in the same category as sales products of the seller group, when selecting at least one seller among the plurality of sellers.

A method for providing an e-commerce platform service according to another embodiment of the present disclosure includes registering a plurality of sellers including at least one top seller and at least one sub-seller subordinate to each of the at least one top seller in a seller DB in a hierarchy corresponding to a seller group, registering sales products of the top seller for each seller group in a sales products DB, generating an online shop of each of the plurality of sellers, the online shop including at least one of registered sales products of the top seller of the seller group to whom the plurality of sellers belong, selecting at least one seller among the plurality of sellers based on the hierarchy, determining at least one design based on a design of the online shop of the selected at least one seller, and recommending the determined at least one design to the seller.

A computer program for providing an e-commerce platform service according to still another embodiment of the present disclosure, the program being stored in a computer readable storage medium and configured to be executed by one or more processors, the computer program includes an instruction for registering a plurality of sellers including at least one top seller and at least one sub-seller subordinate to each of the at least one top seller in a seller DB in a hierarchy corresponding to a seller group, an instruction for registering sales products of the top seller for each seller group in a sales products DB, an instruction for generating an online shop of each of the plurality of sellers, the online shop including at least one of registered sales products of the top seller of the seller group to whom the plurality of sellers belong, an instruction for selecting at least one seller among the plurality of sellers based on the hierarchy, an instruction for determining at least one design based on a design of the online shop of the selected at least one seller, and an instruction for recommending the determined at least one design to the seller.

### BRIEF DESCRIPTION OF THE DRAWINGS

FIG. 1 is a diagram illustrating an e-commerce environment according to various embodiments.

FIG. 2 is a diagram illustrating a configuration of an e-commerce platform server according to an embodiment.

FIG. 3 is a diagram illustrating a hierarchy of sellers according to an embodiment.

FIG. 4 is a diagram illustrating a plurality of seller groups included in the hierarchy of the sellers according to an embodiment.

FIGS. 5A and 5B are diagrams illustrating recommending a design of an online shop in a process of generating a new online shop according to an embodiment.

FIGS. 6A and 6B are diagrams illustrating recommending the design of the online shop in a process of providing consulting information according to an embodiment.

FIG. 7 is a flowchart illustrating a method for recommending the design of the online shop according to an embodiment.

### DETAILED DESCRIPTION

Hereinafter, various embodiments of the present disclosure are described with reference to the attached drawings. However, this is not intended to limit the present disclosure to specific embodiments, and should be understood to include various modifications, equivalents, and/or alternatives to the embodiments of the present disclosure.

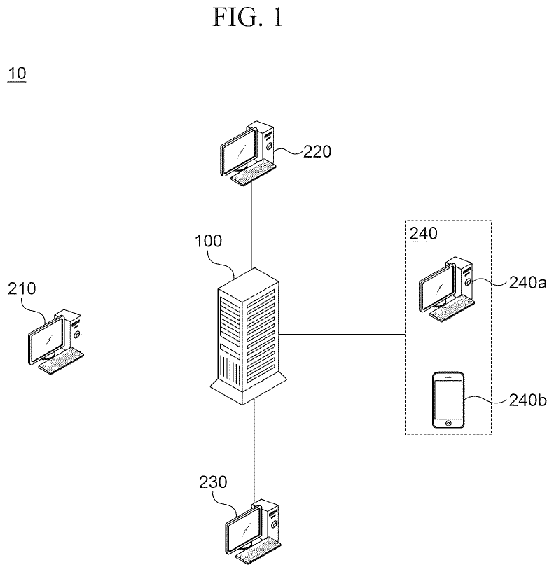

FIG. 1 is a diagram illustrating an e-commerce environment according to various embodiments.

Referring to FIG. 1, the e-commerce environment 10 may include a platform server 100, a supplier terminal 210, a seller terminal 220, a content creator terminal 230, and a purchaser terminal 240. The platform server 100 may be connected to the supplier terminal 210, the seller terminal 220, the content creator terminal 230, and the purchaser terminal 240 through a communication network.

The platform server 100 can provide an e-commerce platform service through the user terminals 210, 220, 230, and 240. The e-commerce platform service may include overall services required to sell products online, such as product supply, sales, promotion, and purchase.

According to one embodiment, the platform server 100 may provide the supplier with a service necessary to supply products on the platform through the supplier terminal 210.

According to one embodiment, the platform server 100 may register a supplier of a product to be sold in the platform service through the supplier terminal 210. The supplier may be, for example, a person who supplies the product to be sold in the platform service and delivers the product sold by a seller. Accordingly, the supplier may be a person who is only responsible for product distribution and delivery and entrusts the rest to other users. According to one embodiment, registering with the platform service may be understood as registering with the platform service as a participant performing a designated role. According to one embodiment, the supplier may be approved for registration according to a designated criterion. The designated criterion may include, for example, a criterion for determining the reliability of the supplier, such as business period, capital size, sales size, brand value, etc. According to one embodiment, the supplier may be approved according to a strict criterion (or high criterion). Accordingly, the products can be stably supplied on the platform by highly reliable suppliers.

According to one embodiment, the platform server 100 may register supply products of the supplier in the platform service through the supplier terminal 210. According to one embodiment, the products may be approved for registration according to a designated criterion. The designated criterion may include, for example, a criterion for predicting a sales volume of the products, such as product quality, consumer preference, brand involvement, market share, distribution margin structure, and availability of exclusive distribution. According to one embodiment, the product may be approved according to a strict criterion. Accordingly, the products with high sales volume are registered and users (e.g., sellers, content creators) who can contribute to promoting product sales participate more in the platform service, which results in high synergy.

According to one embodiment, the platform server 100 may provide a total solution required to supply the products through the supplier terminal 210. For example, the platform server 100 may provide a solution that includes services for managing registration and sale of the supply products and the community. The service for managing product sales may include, for example, services for providing sales information for the registered supply products, managing inventory of the supply products, and managing order, delivery, and refunds. According to one embodiment, the platform server 100 may provide settlement information for the products sold through an online shop of the seller. According to one embodiment, the platform server 100 may provide a solution required to supply the products through a graphic user interface (GUI).

According to one embodiment, the platform server 100 may provide the service required for product sales to the seller through the seller terminal 220.

According to one embodiment, the platform server 100 may register the seller in the platform service through the seller terminal 220. The seller may be, for example, a person who sells the supply products registered in the platform service by the supplier. According to one embodiment, the sellers may be arranged to form a hierarchy. The hierarchy may, for example, consist of an upper seller and sub-sellers subordinate to the upper seller. According to one embodiment, the sub-seller who is subordinate to the upper seller may be subordinate to the upper seller in terms of products that can be sold and sales conditions, and may be required to pay a portion of the sales amount as a commission to the upper seller. According to one embodiment, the seller may be approved for registration based on a designated criterion. The designated criterion may be applied differently depending on, for example, a stratum of the seller. A top seller may be approved for registration on a strict criterion basis based on reliability equivalent to that of the supplier, such as sales size, capital size, and human network size. The sub-sellers (e.g., second-stratum sellers, third-stratum seller) may be registered in the platform service with the approval of the upper seller. Accordingly, under the direction of a highly reliable top seller, the supply products registered in the platform service can be sold in various ways in professional and several online shops (or online shopping malls).

According to one embodiment, the platform server 100 may register sales products of the seller in the platform service through the seller terminal 220. For example, the platform server 100 may register the sales products of the top seller. In other words, the platform server 100 may allow only the top seller to apply for sales approval of a new product. For example, sub-sellers of the top seller cannot directly apply for sales approval of the new product, but can select and sell a product from within the products approved for sale of the top seller. According to one embodiment, the sales products may be approved according to a designated criterion. The designated criterion of sales products may include, for example, a criterion for determining whether the product can be sold professionally, such as the seller's activity area, capital size, existing sales products, sales size, etc. According to one embodiment, an approval criterion for the sales products may be high. Accordingly, product information about the supply products registered in the platform service is delivered to purchasers who are interested in the product through appropriate marketing methods by professional sellers, thereby recording high sales, thereby capable of bringing high profits not only to suppliers but also to users who contribute to product sales (e.g., sellers, content creators).

According to one embodiment, the platform server 100 may provide a solution for generating an online shop within the platform. For example, the platform server 100 may provide a function to set up the online shop using a drag and drop method through a GUI without hard coding. In addition, the platform server 100 may provide a pre-made design template. According to one embodiment, the platform server 100 may register the sales products of the seller in the online shop. For example, the sales products may be the products that have been approved for sale for the seller. According to one embodiment, the platform server 100 may generate an online shop requested by the seller. For example, the platform server 100 may generate an online shop generated by each seller. Each seller may generate a separate online shop according to his or her preferences. Accordingly, the purchaser may selectively subscribe to the online shop that suits his or her tastes on the platform service and purchases the product registered in the online shop as a member.

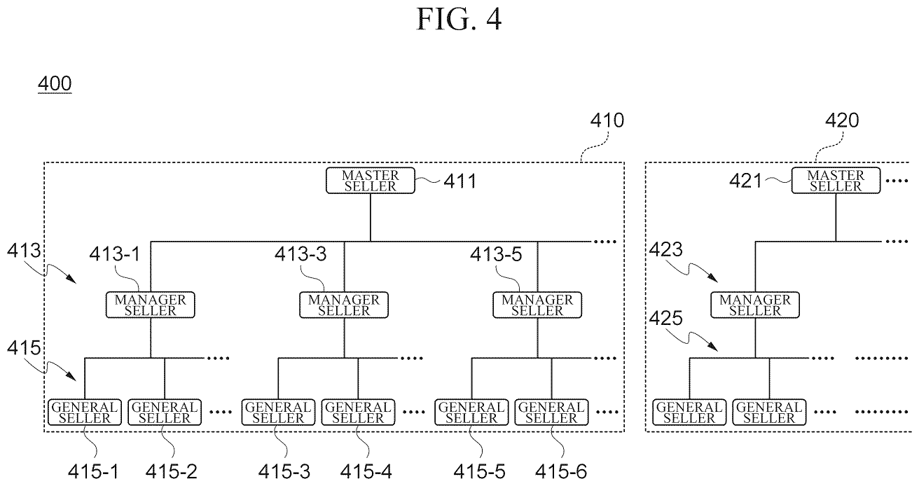

According to one embodiment, the platform server 100 may recommend the design of the online shop to the seller who has requested the generation of an online shop through the seller terminal 220. According to one embodiment, the platform server 100 may recommend the design of the online shop to the requesting seller based on information of the seller. For example, the platform server 100 may recommend the design of the online shop to the requesting seller based on the seller group, sales products, content to be uploaded to the online shop of the seller, etc. For example, the seller group may be a group consisting of at least one subordinate seller centered around the one top seller. The seller group will be described in detail with reference to FIG. 4.

According to one embodiment, the platform server 100 may select at least one seller from a plurality of sellers based on the information of the seller in order to determine the recommended design. For example, the platform server 100 may select the at least one seller based on the hierarchy of the sellers. According to one embodiment, the platform server 100 may determine a recommended design to be recommended to the seller based on the design of the selected at least one seller. For example, the platform server 100 may determine the design of the online shop of the selected seller, or a design generated using parts of the design of the selected seller, as the recommended design. According to one embodiment, the platform server 100 may recommend the determined design to the seller who has requested the generation of the online shop.

According to one embodiment, the platform server 100 may generate an online shop by applying the recommended design. For example, the platform server 100 may generate the online shop to which the recommended design is applied according to request of the user.

Accordingly, the registered seller may sell products through the online shop to which the design appropriate for the products to be sold is applied.

According to one embodiment, the platform server 100 may provide a sales service for the products registered in the generated online shop to the user who visits the platform. For example, the platform server 100 may allow the user who directly visits the platform to search for the product through routes within the platform (e.g., search, online shop visit) and purchase the searched product. Information on the product registered in the online shop may, for example, be made unsearchable through a portal service (e.g., Naver, Yahoo). Accordingly, it is possible to increase user loyalty to the platform service and prevent the suppliers and the sellers from bleeding due to excessive competition for the lowest price.

According to one embodiment, the platform server 100 may provide consulting information to the seller who has sold the products through the online shop. For example, the platform server 100 may provide consulting information for increasing sales of the online shop based on a sales history of the online shop. According to one embodiment, the platform server 100 may recommend sales products (or a category of sales products) through the consulting information. According to one embodiment, the platform server 100 may recommend the design of the online shop to the seller through the consulting information. For example, the platform server 100 may recommend the design of the online shop based on the sales amount of the online shop. For example, the recommended design may be determined based on the design of the online shop of the seller with high sales amount. According to one embodiment, the seller with the high sales amount may be selected similarly to a case of recommending a design in a process of generating the online shop for a newly registered seller. According to one embodiment, the platform server 100 may apply the recommended design to an existing online shop according to a request of the seller. Accordingly, the seller may sell products through the online shop of which design is improved by applying the recommended design through the consulting information.

According to one embodiment, the platform server 100 may provide the total solution required to sell the products through the seller terminal 220. For example, the platform server 100 may provide a solution that includes services for managing online shop, human resources, registration of the sales products, sales of sales products, and the community of the online shops. The service for managing human resources may include, for example, a service for managing sub-sellers and members. The service for managing the sales of sales products may include services that provide sales information for products sold, and manage orders, delivery, and refunds. According to one embodiment, the platform server 100 may provide settlement information for the product sold through the online shop. According to one embodiment, the platform server 100 may provide state information of the sub-seller subordinate to the upper seller in the hierarchy. The state information may include, for example, information about the human resources, product sales, and community. According to one embodiment, the platform server 100 may provide a solution required for selling products through a GUI.

According to one embodiment, the platform server 100 may provide a service required for supplying content to the supplier through the content creator terminal 230.

According to one embodiment, the platform server 100 may register the content creator in the platform service. For example, the content creator may create content that helps sell the product and provide the created content to the supplier and the seller. According to one embodiment, the content creator may be an expert who is directly or indirectly required to create content. The professional personnel may include, for example, a model, a hair and makeup expert, a stylist, a photographer, etc. In addition, the model may be an influencer or celebrity on online social media.

According to one embodiment, the platform server 100 may provide a service that allows the content created by the content creator to be shared with platform users. For example, the platform server 100 may provide a content sharing service using the platform users as a social network, that is, a social network service (SNS). According to one embodiment, the platform server 100 may register content of the content creator in the platform service. According to one embodiment, the platform server 100 may provide the registered content to the platform users through the content sharing service. The content shared through the content sharing service may be content for promoting the product sold on the platform service. According to one embodiment, the content may include information (e.g., URL) about the online shop within the platform where the product being promoted is sold. Accordingly, the purchaser may move to a designated shopping mall using the information and purchase the product. According to one embodiment, the platform server 100 may provide information about participants who participated in creating the content (e.g., the model, the hair and makeup expert, the stylist, the photographer, etc.) along with the content. Accordingly, the supplier and the purchaser may easily check not only the model but also all parties required for content creation.

According to one embodiment, the platform server 100 may provide a service for connecting the supplier and the seller to the content creator. According to one embodiment, the platform server 100 may connect the supplier and seller who wish to request the creation of content for promoting the product to the content creator. For example, the platform server 100 may connect not only the model matching an image of the product but also participants required for content creation, such as the hair and makeup expert and the stylists, all at once. According to one embodiment, the platform server 100 may connect the supplier who want to sponsor a product and the seller to the content creator. According to one embodiment, the platform server 100 may connect the content creator expected to have a high promotional effect to the supplier and the seller. For example, the platform server 100 may connect the content creator who is expected to have the high promotional effect based on the previously created content, sales of the product of the created content, etc.

According to one embodiment, the platform server 100 may provide a total solution required for supplying content through the content creator terminal 230. For example, the platform server 100 may provide a solution including a service for managing contracts with the supplier and the seller, profits, and settlement. According to one embodiment, the platform server 100 may provide profit information according to content creation. According to one embodiment, the platform server 100 may provide a solution required for supplying content through the GUI.

According to one embodiment, the platform server 100 may provide a service required for purchasing the product to the purchaser through the purchaser terminal 240.

According to one embodiment, the platform server 100 may register the purchaser as a member in the online shop of the seller. For example, the platform server 100 may register the purchaser as a member in the online shop of each seller.

According to one embodiment, the platform server 100 may receive order and delivery information of the purchaser who purchased the product through the online shop. According to one embodiment, the platform server 100 may provide a payment service to the purchaser who purchased the product. According to one embodiment, the platform server 100 may transmit order information to the supplier and the seller when payment is completed. Accordingly, the supplier may deliver the ordered product to the purchaser.

According to one embodiment, the platform server 100 may provide a service for managing an order state through the purchaser terminal 240. According to one embodiment, the platform server 100 may provide order and delivery information for the product purchased from the online shop. According to one embodiment, when the platform server 100 receives order correction information, the platform server 100 may modify the order information based on the received correction information.

According to one embodiment, a manager of the platform server 100 may approve registration of the platform service. According to one embodiment, the manager of the platform server 100 may approve registration of the platform user. For example, the manager may approve registration of the supplier and the seller. The seller for the registration approval may be, for example, the top seller. According to one embodiment, the manager of the platform server 100 may approve registration of the product. For example, the manager may approve the supply products of the supplier and the sales products of the seller. For example, the sales products may sales products of the top seller. According to one embodiment, the manager of the platform server 100 may access the platform server 100 through a separate terminal and approve the registration of the service.

According to one embodiment, the manager of the platform server 100 may check state information for managing an overall state of the supplier and the seller. The state information may include, for example, sales information (e.g., sales amount information, settlement information, delivery information, etc.), settlement information, and order and delivery information. According to one embodiment, the manager of the platform server 100 may check community information. The community information may include, for example, an online shop, and notices, FAQ, Q&A, reviews, etc. about products sold in the online shop.

According to one embodiment, the manager of the platform server 100 may register the supplier, seller, and content creator introduced by a collector according to the procedure described above. According to one embodiment, the collector is a separate entity from the manager and may play a role in encouraging more users to participate in the platform service.

According to one embodiment, the platform server 100 may include a database (DB) for data storage as well as a computing module required for providing the e-commerce platform service. In other words, the platform server 100 may include a server configuration generally required for providing the e-commerce service. According to one embodiment, the platform server 100 may provide useful information to the service users by analyzing information stored in the database. The useful information may include, for example, basic data useful for product supply, product sales, content creation, and product purchase, and processed data.

The supplier terminal 210 may be a terminal of the supplier for using the e-commerce platform service provided to the supplier from the platform server 100.

According to one embodiment, the supplier terminal 210 may receive information for managing product supply from the platform server 100. For example, the supplier terminal 210 may receive information for registering supply products, selling supply products, and managing a community for supply products. According to one embodiment, the supplier terminal 210 may transmit information input from the supplier to the platform server 100 in order to manage product supply. For example, the supplier terminal 210 may transmit application information for registering new supply products. In addition, the supplier terminal 210 may transmit information input from the supplier in order to manage ordering, delivery, and community of the supply products. According to one embodiment, the supplier terminal 210 may provide information for managing product supply to the supplier through the GUI and receive information required for managing product supply from the supplier.

The seller terminal 220 may be a terminal of the seller for using the e-commerce platform service provided to the seller from the platform server 100.

According to one embodiment, the seller terminal 220 may receive a service for generating a shopping mall provided from the platform server 100. The service for generating the online shop may include information required for generating the shopping mall, for example, in a way of dragging and dropping through the GUI and providing a template. According to one embodiment, the seller terminal 220 may transmit information input from the seller to the platform server 100 in order to generate the online shop. Accordingly, the online shop of the seller may be generated on the platform.

According to one embodiment, the seller terminal 220 may receive information for managing product sales from the platform server 100. For example, the seller terminal 220 may receive information for managing registration of sales products, sales of sales products, managing human resources, and managing the community of the online shop. The human resource management may include, for example, managing the sub-seller and the member. According to one embodiment, the seller terminal 220 may transmit information input from the seller to the platform server 100 in order to manage product sales. For example, the seller terminal 220 may transmit an application for registering a new sales product. The application for the new sales product may be made, for example, by the top seller. In addition, the seller terminal 220 may transmit information input from the seller in order to manage the order, delivery, and community of supply products. According to one embodiment, the seller terminal 220 may provide information for managing product supply to the seller through the GUI and receive information required for managing product sales from the seller.

The content creator terminal 230 may be the seller terminal for using the e-commerce platform service provided to the content creator from the platform server 100.

According to one embodiment, the content creator terminal 230 may receive a service for sharing content with the platform users from the platform server 100. The service by which the content can be shared may be, for example, SNS that uses the platform users as a social network. According to one embodiment, the content creator terminal 230 may transmit the created content to the platform server 100. Accordingly, the content of the content creator may be shared on the platform.

According to one embodiment, the content creator terminal 230 may receive a content creation request and sponsorship provision information from the platform server 100. According to one embodiment, the content creator terminal 230 may transmit a response accepting the creation request and sponsorship provision to the platform server 100. Accordingly, content creation or sponsorship contract with the supplier or seller may be concluded.

According to one embodiment, the content creator terminal 230 may receive information for managing the content creation from the platform server 100. For example, the content creator terminal 230 may receive contract information, profit information, and settlement information from the platform server 100. According to one embodiment, the creator terminal 220 may provide the received information to the seller through the GUI and receive information required for managing the content creation and sponsorship contract from the content creator.

The purchaser terminal 240 may be a purchaser terminal for using the e-commerce platform service provided to the purchaser from the platform server 100.

According to one embodiment, the purchaser terminal 240 may receive online shop information. According to one embodiment, the purchaser terminal 240 may transmit order information of a consumer. Accordingly, a product purchase may be made.

According to one embodiment, the user terminals 210, 220, 230, and 240 may be general-purpose devices such as desktop personal computers (PCs), notebook PCs, smartphones, tablet PCs, and personal digital assistants (PDAs). For example, the supplier terminal 210, the seller terminal 220, and the user terminal 230 may be electronic devices having relatively low portability, such as desktop PCs and notebook PCs, and the purchaser terminal 240 may be the smartphone 240b as well as the desktop PC 240a having low portability.

The e-commerce environment 10 described above may provide the e-commerce platform service in which the suppliers who supply products, the sellers who generate online shops to sell the products, and creators who create content to promote the products coexist on one platform, the products are sold to the purchasers, and profits from product sales are shared.

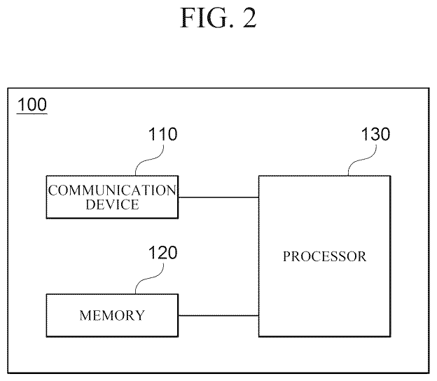

FIG. 2 is a diagram illustrating a configuration of the e-commerce platform server according to an embodiment.

Referring to FIG. 2, the platform server 100 may include a communication device 110, a memory 120, and a processor 130. However, not all of the illustrated components are essential components. The platform server 100 may be implemented with more components than the illustrated components, and the platform server 100 may be implemented with fewer components than the illustrated components.

The communication device 110 may communicate with an external device. For example, the communication device 110 may be connected to a network in a wired manner or wirelessly to communicate with the external device. Here, the external device may be a user terminal (e.g., the user terminals 210, 220, 230, and 240 of FIG. 1).

The communication device 110 may include a communication module that supports one of various wired and wireless communication methods. The communication module may be a short-distance communication module or a wired communication module.

The memory 120 may include at least one type of storage medium among flash memory type, hard disk type, multimedia card micro type, card type memories (SD, XD memory, etc.), semiconductor memories such as a random access memory (RAM), static random access memory (SRAM), read-only memory (ROM), electrically erasable programmable read-only memory (EEPROM), and programmable read-only memory (PROM), a magnetic disk, and an optical disk.

The memory 120 may store at least one program for providing e-commerce platform service, in which users for product supply, product sales, content provision, and product purchase participate, from the platform server 100. At least one program stored in the memory 1020 may be classified into a plurality of modules according to functions.

The memory 120 may include DBs for registering information on the products, suppliers, sellers, content creators, and purchasers. However, each of the DBs is a separate storage device and may be implemented outside of the platform server 100 and connected thereto directly or through a communication network.

The processor 130 controls the overall operation of the platform server 100 and may include at least one processor such as a CPU. The processor 130 may include at least one specialized processor corresponding to each function, or may be an integrated processor.

The processor 130 may execute a program stored in the memory 120, read data or files stored in the memory 120, or store a new file in the memory 120. In addition, the processor 130 may execute instructions stored in the memory 120. Accordingly, the processor 130 may perform the following operations.

The operation performed by executing the instructions by the processor 130 may be understood as an operation of the platform server (e.g., platform server 100 of FIG. 1).

According to one embodiment, the processor 130 may register the supplier of the product to be sold in the platform service in a supplier DB through a supplier terminal (e.g., supplier terminal 210 of FIG. 1). According to one embodiment, being registered in the DB may be understood as storing information on a target to be registered. In addition, storing target information in the DB may be understood as registering the target in the platform service.

According to one embodiment, the processor 130 may receive application information for registering as the supplier from the supplier terminal. The application information may include, for example, supplier information that can identify the supplier and determine whether or not to register the supplier.

According to one embodiment, the processor 130 may determine whether or not to register the supplier based on a response of the manager of the platform service. Whether or not to register the supplier may be determined based on a designated criterion that can determine, for example, the reliability of the supplier. According to another embodiment, the processor 130 may determine whether or not to register the supplier based on the designated criterion. For example, the processor 130 may automatically determine whether or not to register the supplier based on a criterion stored in the memory 120. According to one embodiment, the processor 130 may register the supplier in the supplier DB according to the determination of whether or not to register the supplier.

According to one embodiment, the processor 130 may register the supply product in the supply products DB through the supplier terminal. The supply product may be, for example, the product of the supplier product to be sold on the platform service. According to one embodiment, the processor 130 may receive application information for registering the supply product from the supplier terminal. For example, the application information may include supply product information that can identify the supply product and determine whether or not the supply product is registered. According to one embodiment, the processor 130 may determine whether or not to register the supply product based on a response of the manager of the platform service. Whether or not to register the supply product may be determined, for example, based on a designated criterion that can predict the sales volume of the product. According to another embodiment, the processor 130 may determine whether or not to register the supply product based on the designated criterion. For example, the processor 130 may automatically determine whether or not to register the supply product based on a criterion stored in the memory 120. According to one embodiment, the processor 130 may register the supply product in the supply products DB according to the determination of whether or not to register the supply product.

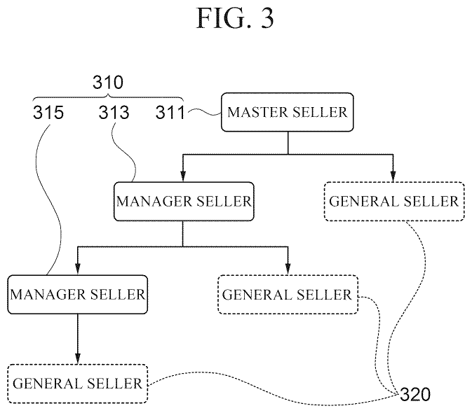

According to one embodiment, the processor 130 may register the seller in the seller DB through the seller terminal (e.g., seller terminal 220). For example, when registering a plurality of sellers in the seller DB, the processor 130 may register the plurality of sellers in the seller DB in the hierarchy consisting of the upper seller and at least one sub-seller subordinate to the upper seller. According to one embodiment, the processor 130 may register the plurality of sellers in a hierarchy in the seller DB. For example, the processor 130 may register a plurality of sellers, including at least one top-level seller and sub-sellers subordinate to each of the at least one top-level seller, in a hierarchy corresponding to a seller group in the seller DB. For example, the hierarchy may include at least one seller group in which at least one subordinate sub-seller forms a hierarchy centered around a top seller. According to one embodiment, the processor 130 may register the top seller in the hierarchy as a master seller in the seller DB, and register the sub-sellers subordinate to the top seller as manager sellers and general sellers subordinate to the manager sellers in the seller DB. According to one embodiment, the processor 130 may grant designated authority to the manager seller so as to manage the general sellers. The hierarchy will be described in more detail in FIGS. 3 and 4.

According to one embodiment, the processor 130 may receive application information for registering as the seller from the seller terminal. For example, the application information may include seller information that can identify the seller and determine whether or not to register the seller.

According to one embodiment, the processor 130 may determine whether or not to register the top seller based on a response to the manager of the platform service. For example, the processor 130 may provide the received product information to the manager and determine whether or not to register as the top seller according to whether or not the manager approves the top seller. Whether or not to register the top seller may be determined, for example, based on a designated criterion that can determine the reliability of the seller. The designated criterion may be a predetermined criterion in order to objectively determine the reliability of the seller.

According to one embodiment, the processor 130 may determine whether or not to register a sub-seller who is subordinate to the upper seller based on a response of the upper seller. For example, the processor 130 may transmit the information on the sub-seller to the terminal of the upper seller to whom the sub-seller is subordinate, receive a response determining whether or not to register from the terminal of the upper seller, and determine whether or not to register the sub-seller according to the received response. For example, whether or not to register the sub-seller may be determined based on a subjective criterion of the top seller, different from the top seller. According to another embodiment, the processor 130 may determine whether or not to register the seller based on a designated criterion. For example, the processor 130 may automatically determine whether or not to register the seller based on the criterion stored in the memory 120. According to one embodiment, the processor 130 may register the seller in the seller DB according to the determination of whether or not to register.

According to one embodiment, the processor 130 may register the sales products in the sales products DB through the seller terminal. For example, the processor 130 may register the sales products of the top seller in the sales products DB. For example, the sales products may be at least one of the supply products registered in the supply products DB. In other words, at least one of the supply products registered by the supplier may be selected and registered as the sales product. According to one embodiment, the processor 130 may register the sales products of the top seller for each seller group in the sales products DB. Accordingly, the sub-seller subordinate to each of the at least one top seller may sell products within the registered sales products of the top seller to which the sub-seller subordinate.

According to one embodiment, the processor 130 may receive application information for registering the sales products from the top seller terminal. The application information may include, for example, sales product information that can identify the product, and seller information required for determining whether or not to register the sales products. According to one embodiment, the processor 130 may determine whether or not to register the sales products based on the response of the platform service manager. For example, whether or not to register the sales products may be determined based on the criterion for determining whether or not the products can be sold professionally.

According to one embodiment, the processor 130 may allow sub-sellers subordinate to the top seller to sell the products within the registered sales products of the top seller. In other words, the sales products of the sub-sellers are subordinate to the registered sales products of the top seller to whom the sub-sellers are subordinate. In addition, the sub-sellers cannot request registration of separate sales products. According to another embodiment, the processor 130 may determine whether or not to register the sales products according to a designated criterion. For example, the processor 130 may automatically determine whether or not to register the sales products based on the criterion stored in the memory 120. According to one embodiment, the processor 130 may register the sales product in the sales products DB according to the determination of whether or not to register.

According to one embodiment, the processor 130 may provide a solution for generating the online shop within the platform through the seller terminal. According to one embodiment, the processor 130 may receive a user input for setting up the online shop from the seller terminal. The user input may be, for example, dragging and dropping the configuration of the online shop to a designated location through the GUI. In addition, the user input may be input based on a pre-made design template. According to one embodiment, the processor 130 may generate an online shop in which at least one of the products registered in the sales products DB is registered based on the received user input. According to one embodiment, the processor 130 may generate the online shop for each of a plurality of registered sellers. For example, the processor 130 may generate the online shop of the sub-seller subordinate to the top seller. For example, the generated online shop may include at least one of the registered sales products of the top seller registered in the sales products DB. In other words, the online shop may include at least one of the registered sales products of the top seller of the seller group to which the seller belongs. In addition, it is possible to generate an online shop of the top seller as well as the sub-seller.

According to one embodiment, the processor 130 may recommend the design of the online shop to the seller through the seller terminal. For example, the processor 130 may recommend the design of the online shop to the seller based on information of the seller. The design of the online shop may include, for example, information about a layout of a configuration (e.g., menu, products, etc.) of the online shop and the style of content (e.g., product description, image, etc.) included in the configuration.

According to an embodiment, the processor 130 may select at least one seller among a plurality of registered sellers based on information of the seller in order to recommend the design of the online shop. For example, the processor 130 may select at least one seller among the plurality of sellers based on the hierarchy of sellers.

According to one embodiment, the processor 130 may select at least one seller among a plurality of sellers of a seller group that includes a seller for whom design is recommended.

According to one embodiment, the processor 130 may select at least one seller among the plurality of sellers included in the seller group based on similarity of the content included in the configuration of the online shop. For example, the processor 130 may select at least one seller whose content input by the seller in order to upload to each configuration of the online shop is similar. The similarity of the content may be determined based on, for example, information about the type of sales products, the image of the sales products, and the description of the sales products. According to one embodiment, since sub-sellers may sell different products within the registered products of the top seller even when the sub-sellers are included in the same seller group, not only the image and description of the sales products, but also the type of sales products may be a criterion for determining the similarity of the content within the same seller group. According to one embodiment, the processor 130 may determine the similarity using a score calculated by differentially assigning scores to identical or similar parts, such as the number of identical products, number of images, image size, text description of sales products, etc. According to one embodiment, the processor 130 may select at least one seller that has a designated score or higher or a designated rank or higher.

According to one embodiment, the processor 130 may select at least one seller having the designated rank or higher, among a plurality of sellers included in the seller group, based on information related to sales of the online shop. For example, the processor 130 may select at least one seller using history information directly or indirectly related to sales of the online shop. The information related to sales of the online shop may include, for example, sales amount information, member subscription rate information, information on a length of time that a visitor stays in the online shop, information on a probability of revisit of the visitor, and purchase rate information of the visitor. According to one embodiment, the processor 130 may select at least one seller having a rank higher than or equal to the designated rank using a score calculated by assigning differential scores to sales amount, number of members, visit time, probability of revisit, probability of visit leading to purchase, etc.

According to one embodiment, the processor 130 may select at least one seller among the sub-sellers included in the seller group. For example, the processor 130 may select at least one seller among sub-sellers (e.g., bottom sellers) whose main job is to sell products in the seller group. According to one embodiment, the processor 130 may select at least one seller among general sellers who sell registered products of the master seller under the management of the manager seller to whom the general sellers subordinate. The general seller may be, for example, a seller whose main role in the hierarchy is selling products. Accordingly, the design of the online shop of the general seller may be a design that may be referenced for increasing sales.

According to one embodiment, the processor 130 may select at least one seller among a plurality of sellers included in the seller group of another top seller who has registered products in the same category as the sales products of the top seller to whom the seller, for whom design was recommended, is subordinate. In other words, the processor 130 may select at least one seller among a plurality of sellers included in another seller group selling products in the same category as the registered products of the top seller.

According to one embodiment, the processor 130 may apply a plurality of methods for selecting at least one seller based on the hierarchy mentioned above. For example, the processor 130 may select at least one seller among sub-sellers of a seller group based on the similarity of the content included in the configuration of the online shop or information related to sales. For another example, the processor 130 may select at least one seller among a plurality of sellers included in the seller group of another top seller who has registered products in the same category, based on the similarity of the content included in the configuration of the online shop or information related to sales. In addition, the processor 130 may select at least one seller among sub-sellers of the other seller group. Meanwhile, the processor 130 may select at least one seller by combining the methods mentioned above in various ways.

According to one embodiment, the processor 130 may determine at least one design based on the design of the online shop of the selected at least one seller. According to one embodiment, the processor 130 may determine the design of the online shop of the selected at least one seller as the recommended at least one design. In other words, the processor 130 may determine the design applied to each online shop of the selected at least one seller as the recommended design. According to one embodiment, the processor 130 may determine a new design obtained by selectively combining parts of the design of the online shop of the selected at least one seller as the recommended at least one design. For example, the processor 130 may determine a new design obtained by selectively combining the layout of the configuration of the online shop of the selected at least one seller and the style of content included in the configuration.

According to one embodiment, the processor 130 may recommend the determined at least one design to the seller who requested the generation of the online shop in the process of generating the online shop. For example, the processor 130 may recommend the determined design in the process of generating the online shop of a newly registered seller.

According to one embodiment, the processor 130 may recommend the determined at least one design to the seller in the process of providing consulting information based on information on the history of product sales through the generated online shop. For example, the processor 130 may determine the determined at least one design through consulting information provided to the seller who is already selling products through the generated online shop. According to one embodiment, when recommending the design in the process of providing the consulting information, the processor 130 may select at least one seller with higher sales amount than the seller for whom the design is recommended, among at least one of the seller group that includes the seller for whom the design is recommended and another seller group that sells products in the same category as the sales products of the seller group. According to one embodiment, the processor 130 may determine the recommended design based on the design of the selected at least one seller.

According to one embodiment, the processor 130 may apply the recommended design to the online shop. For example, the processor 130 may apply one of the at least one recommended design to an online shop according to the request of the seller. The request of the seller may be, for example, a request to select one of the at least one recommended design. Accordingly, the seller may sell products through the online shop to whom the recommended design is applied.

According to one embodiment, the processor 130 may set a profit rate for distributing the profits of the products sold through the seller terminal. According to one embodiment, the processor 130 may receive information for setting the profit rate of the seller according to the hierarchy from the terminal of the top seller. For example, when receiving information for setting the profit rate of the top seller, the processor 130 may recommend the profit rate of the sub-seller subordinate thereto. According to one embodiment, the processor 130 may set the profit rate for the sellers in the hierarchy according to the received information for setting the profit rate. For example, when receiving the input of the top seller who agrees with the recommended profit rate, the processor 130 may set the profits of the sellers in the hierarchy according to the recommended profit rate.

According to one embodiment, the processor 130 may register the content creator in the content creator DB through a content creator terminal (e.g., the content creator terminal 230 of FIG. 1). According to one embodiment, the processor 130 may receive application information for registering as the content creator from the content creator terminal. The application information may include, for example, information for identifying the content creator. According to one embodiment, the processor 130 may register the content creator based on the received application information. The content creator may be, for example, an expert directly or indirectly required to create content.

According to one embodiment, the processor 130 may provide a service for sharing the content with the platform users through the content creator terminal. According to one embodiment, the processor 130 may receive the content for promoting the product registered in at least one of the supply products DB and the sales products DB from the content creator terminal. According to one embodiment, the processor 130 may register the received content in a content DB. According to one embodiment, the processor 130 may provide the content registered in the content DB to the platform user. For example, the processor 130 may provide the purchaser with the content uploaded to a space where the content creator can be identified through the terminal of the purchaser. The content may be, for example, requested by the supplier or the seller through the platform service.

According to one embodiment, the processor 130 may provide a service for connecting the supplier and seller to the content creator through the content creator terminal. For example, the processor 130 may request the creation of content for promoting the product, or connect the supplier and seller to the content creator for sponsoring the product. According to one embodiment, the processor 130 may upload the connected content to the online shop of the seller and provide the content to the user of the platform service. For example, the processor 130 may provide a product purchase page, in which the content is uploaded, through the purchaser terminal.

According to one embodiment, the processor 130 may provide recommendation information about the content creator expected to have a high promotional effect through the supplier terminal and the seller terminal. The recommended information may be provided, for example, based on information on the content that has been created.

According to one embodiment, the processor 130 may provide the service required for purchasing the product to the purchaser through the purchaser terminal (e.g., the purchaser terminal 240 of FIG. 1). According to one embodiment, the processor 130 may receive purchase information of the purchaser who purchased the product from the purchaser terminal. According to one embodiment, the processor 130 may transmit the received order information to the supplier terminal and the seller terminal when payment is completed. For example, the processor 130 may transmit the received order information to the supplier terminal and allow the supplier to deliver the product to the purchaser.

Accordingly, the e-commerce platform server 100 can provide the platform service for selling the products online.

FIG. 3 is a diagram illustrating the hierarchy of the sellers according to an embodiment.

Referring to FIG. 3, a plurality of sellers 310 may be registered in a hierarchy consisting of upper sellers and sub-sellers.

According to one embodiment, the plurality of sellers 310 may be connected to the platform server (e.g., platform server 100 of FIG. 1) through the seller terminal (e.g., seller terminal 220 of FIG. 1) and transmit and receive information for using the platform service. The actions (or operations) of the plurality of sellers 310 below may be understood as being performed through the seller terminal.

According to one embodiment, the hierarchy of the plurality of sellers 310 may consist of upper sellers and sub-sellers subordinate to the upper sellers. The fact that the sub-seller is subordinate to the upper seller may mean that the authority within the platform service of the sub-seller is subordinate to the authority of the upper seller. In other words, being subordinate may mean that the authority of the sub-seller may be determined within the authority of the upper seller. The authority may, for example, relate to the scope of determinations that can be made when registering and selling products in the platform service, such as whether or not to register the seller, sales products, sales conditions, etc.

According to one embodiment, the hierarchy of the sellers 310 may consist of a plurality of stratums. For example, each of the plurality of stratums may be sequentially subordinate to a higher stratum thereof. According to one embodiment, the hierarchy of the sellers 310 may consist of a master seller 311, a manager seller 313, and a general seller 315. In addition, the hierarchy of the sellers 310 may include three or more stratums. For example, in the hierarchy of the sellers 310, the manager seller 313, which consists of a plurality of stratums, may be registered.

According to one embodiment, the master seller 311 may be the top seller in the hierarchy. In other words, the master seller 311 may not have an upper seller to whom the master seller 311 is subordinate.

According to one embodiment, the master seller 311 may register sales products in the platform service. The sales products may be, for example, at least one of the supply products registered in the platform service by the supplier. According to one embodiment, the master seller 311 may apply for registration of sales products for each product category. The product category may include a plurality of products, such as clothing, household goods, sporting goods, and pet supplies.

According to one embodiment, the master seller 311 may manage sub-sellers (or the manager seller 313 and the general seller 315) subordinate thereto.

According to one embodiment, the master seller 311 may determine whether or not to register the sub-sellers 313 and 315 subordinate thereto. For example, the master seller 311 may determine whether or not to register not only the manager seller 313, who is directly subordinate thereto, but also the general seller 315, who is indirectly subordinate thereto, through the manager seller 313.

According to one embodiment, the master seller 311 may set the profit rate for the sub-sellers 313 and 315. The profit rate may be, for example, a ratio at which profits from products sold by the sub-sellers 313 and 315 are distributed according to the hierarchy. According to one embodiment, the master seller 311 may determine the profit rate when each of the sub-sellers 313 and 315 sells products. According to the determined profit rate, the profit rate for each stratum for products sold by the sub-sellers 313 and 315 may be determined. According to the determined profit rate, the upper sellers and sub-sellers may share the profits from product sales.

According to one embodiment, the master seller 311 may check the sales state, delivery state, and settlement state of the registered sub-sellers 313 and 315.

According to one embodiment, the master seller 311 may generate an online shop that he or she directly operates. In the generated online shop, for example, sales products of the master seller 311 may be registered. According to one embodiment, the master seller 311 may sell products to a purchaser 320 through the generated online shop.

According to one embodiment, the master seller 311 may focus more on registering the sales products and managing the subordinate sub-sellers 313 and 315 rather than directly selling the products to the purchaser 320 through the online shop. According to one embodiment, since the profits of the master seller 311 may be distributed from the sales profits of the sub-sellers 313 and 315 according to the set profit rate, the master seller 311 may focus on managing the sales products and the sub-sellers 313 and 315 rather than directly selling the products. However, when there are few or no sub-sellers 313 and 315 to be managed by the master seller 311, the master seller 311 may also focus on directly selling the products. Accordingly, the master seller 311, as the top seller in the hierarchy, performs the main role of registering the sales products and managing the sub-sellers, thereby capable of increasing profits not only for himself or herself but also for the entire seller group centered around the master seller 311.

According to one embodiment, the manager seller 313 may be an intermediate seller in the hierarchy. In other words, the manager seller 313 may have an upper seller to whom the manager seller 313 is subordinate and a sub-seller subordinate to the manager seller 313.

According to one embodiment, the manager seller 313 may manage the sub-seller (or general seller 315) subordinate thereto. According to one embodiment, the manager seller 313 may determine whether or not to register the sub-seller 315 and check the sales state, delivery state and settlement state of the sub-seller 315. In other words, the manager seller 313 may be granted designated authority so as to manage the sub-seller 315. The designated authority may include at least one of the authority to determine whether or not to register the sub-seller 315 and the authority to check the sales state, delivery state, and settlement state of the general seller.

According to one embodiment, the manager seller 313 may generate an online shop that the manager seller 313 directly operates. For example, in the generated online shop, at least one sales products of the master seller 311 may be registered. According to one embodiment, the manager seller 313 may sell products within the registered sales products of the master seller 311. According to one embodiment, the manager seller 313 may sell products to the purchaser 320 through the generated online shop.

According to one embodiment, like the master seller 311, the manager seller 313 may focus more on managing the general seller 315 subordinate thereto rather than selling products directly to the purchaser 320 through the online shop. According to one embodiment, since the profits of the manager seller 313 may be distributed from the sales profits of the general seller 315 according to the profit rate set by the master seller 311, the manager seller 313 may focus more on managing the sub-seller 315 rather than directly selling products. However, when there are few or no general sellers 315 to be managed by the manager seller 313, the manager seller 313 may also focus on directly selling products. Accordingly, the manager seller 313, as an intermediate seller in the hierarchy, performs a main role (or intermediate manager role) of managing the general seller 315, thereby capable of increasing profits not only for himself or herself but also for the entire seller group centered around the master seller 311.

According to one embodiment, the general seller 315 may be the bottom seller in the hierarchy. In other words, the general seller 315 may not have a sub-seller subordinate thereto.

According to one embodiment, the general seller 315 may generate an online shop in which at least one sales products of the master seller 311 is registered. According to one embodiment, the general seller 315 may sell products within the registered sales products of the master seller 311. According to one embodiment, the general seller 315 may sell products to the purchaser 320 through the generated online shop.

According to one embodiment, the general seller 315, unlike the upper sellers 311 and 313, may focus more on selling products directly to the purchaser 320 through the online shop. According to one embodiment, the general seller 315 may select at least one product to be sold in his or her online shop among the products registered by the master seller 311. For example, the general seller 315 may select a product that can be sold professionally or that have a high sales rate when sold together. For example, the products having the high sales rate when sold together may be products that a visitor to the online shop is likely to purchase together. According to one embodiment, the general seller 315 may set the design of the online shop in which that the selected product will be sold. For example, the general seller 315 may set the layout of the configuration of online shop and the content included in the configuration (e.g., classification, list, description of products, etc.). Accordingly, the general seller 315, as the bottom seller in the hierarchy, performs the main role of selling products, thereby capable of increasing the sales of the seller group centered around the master seller 311.

According to one embodiment, when recommending the design of the online shop to the seller 310, the platform server (e.g., platform server 100 of FIG. 1) may recommend a design determined based on the design of the seller in the stratum in which products are directly sold to the purchaser 320 in the seller group centered around the master seller 311. For example, as described above, the platform server may recommend the design determined based on the design of the online shop of the general seller 315 who sells products directly to the purchaser 320. According to one embodiment, since the main role of the general seller 315 to sell products directly to the purchaser 320, the online shop of the general seller 315 may reflect the most factors that may increase sales. According to one embodiment, the platform server may determine the recommended design based on the design of at least one seller selected from the general seller 315 of the seller group that includes the seller for whom design is recommended. In addition, the platform server may determine the recommend design based on the design of the seller selected among general sellers included in the seller group of another top seller who has registered products in the same category as the sales products of the top seller to whom the seller, for whom design is recommended, is subordinate.

Accordingly, the platform server may recommend the design of online shop that may directly increase sales to the seller 310 based on the characteristics of each stratum of the hierarchy.

FIG. 4 is a diagram illustrating a plurality of seller groups included in the hierarchy of the sellers according to an embodiment.

Referring to FIG. 4, the hierarchy of a plurality of sellers 400 may include at least one seller group 410 and 420 respectively centered around top sellers.

According to one embodiment, each of the seller groups 410 and 420 of the plurality of sellers 400 may consist of a top seller and at least one sub-sellers subordinate to the top seller. For example, the seller groups 410 and 420 of the plurality of sellers 400 may respectively consist of master sellers 411 and 421, a plurality of manager sellers 413 and 423 that are respectively subordinate to the master sellers 411 and 421, and a plurality of general sellers 415 and 425 that are respectively subordinate to the plurality of manager sellers 413 and 423.

According to one embodiment, the first seller group 410 may include the first master seller 411, the first plurality of manager sellers 413 subordinate to the first master seller 411, and the first plurality of general sellers 415 that are respectively subordinate to the plurality of manager sellers 413. According to one embodiment, a plurality of manager sellers including a first manager seller 413-1, a second manager seller 413-3, and a third manager seller 413-5 may be subordinate to the first master seller 411. According to one embodiment, a plurality of general sellers including a first general seller 415-1 and ae second general seller 415-2 may be subordinate to the first manager seller 413-1. And, a plurality of general sellers including a third general seller 415-3 and a fourth general seller 415-4 may be subordinate to the second manager seller 413-3. In addition, a plurality of general sellers including a fifth general seller 415-5 and a sixth general seller 415-6 may be subordinate to the third manager seller 413-5.

According to one embodiment, the first master seller 411, as the top seller of the first seller group 410, may register products sold in the first seller group 410. For example, the first master seller 411 may register sportswear in the clothing category as sales products. According to one embodiment, each of the first plurality of manager sellers 413 may manage sales of the first plurality of general sellers 415 subordinate thereto. According to one embodiment, the first plurality of general sellers 415 may sell at least one of the products registered by the first master seller 411 to the purchaser (e.g., purchaser 320 of FIG. 3) through the online shop. For example, the first plurality of general sellers 415 may sell at least one of the sportswear registered by the first master seller 411 through the online shop. In addition, as described in FIG. 3, the first master seller 411 and the first plurality of manager sellers 413 may also sell registered products through their respective online shops. Accordingly, the first seller group 410 may sell the products registered by the first master seller 411 together.

According to one embodiment, the second seller group 420 may include the second master seller 421, the second plurality of manager sellers 423 subordinate to the second master seller 421, and the second plurality of general sellers 425 that are respectively subordinate to the plurality of manager sellers 423. According to one embodiment, similar to the first seller group 410, the second plurality of manager sellers 423 may be subordinate to the second master seller 421, and, similar to the first seller group 410, the second plurality of general sellers 425 may subordinate to each of the second plurality of manager sellers 423.

According to one embodiment, the second master seller 421 may register products sold in the second seller group 420. For example, the second master seller 421 may register feed of a different pet product category from the first seller group 410 as the sales product. For another example, the second master seller 421 may register everyday clothes (or, casual clothes) in the same clothing category as the first seller group 410 as the sale product. According to one embodiment, the second plurality of manager sellers 423 may manage the second plurality of general sellers 425. According to one embodiment, the second plurality of general sellers 425 may sell at least one of the products registered by the second master seller 421 to the purchaser through the online shop. The second plurality of general sellers 425 may sell at least one of feed in a pet product category different from that of the first seller group 410 through the online shop. For another example, the second plurality of general sellers 425 may sell at least one of everyday clothes in the clothing category similar to that of the first seller group 410 through the online shop.

According to one embodiment, the platform server (e.g., platform server 100 of FIG. 1) may determine the recommended design to the seller of the first seller group 410 based on the design of the online shop of the seller selected from the first seller group 410. For example, the platform server may determine the recommended design based on the design of the online shop of the seller selected from the first seller group 410 that selects and sells the product within the same products (e.g., sportswear). For example, when the recommended design is determined based on the design of the online shop of the seller selected from the second seller group 420 whose sales products are in a different category of pet supplies, the recommended design may not be helpful in selling products of the seller included in the first seller group 410.

According to one embodiment, the platform server may determine the recommended design based on the design of the online shop of the seller selected from the second seller group 420 whose registered sales products are in the same category as those of the seller included in the first seller group 410. In other words, even in the second seller group 420, when sales products in the same category are registered, the platform server may determine the recommended design based on the design of the seller of the second seller group 420. For example, the platform server may determine the recommended design based on the design of the online shop of the seller selected from the second seller group 420 selling everyday clothes in the same clothing category. For example, since the recommended design is determined based on the design of the online shop selling products in the same clothing category, there is a high possibility that the recommended design will also help sell products by the seller included in the first seller group 410, which is different from the second seller group 420.

According to one embodiment, when selecting the seller from the first seller group 410 or the second seller group 420, the platform server may make a determination based on at least one of similarity of the content included in the configuration of the online shop, and information related to the sales of the online shop. The similarity of the content may be determined based on, for example, information about the type of sales products, the image of the sales products, and the text description of the sales products. The information related to the sales of the online shop may include sales amount information, member subscription rate information, information on a length of time that a visitor stays in the online shop, information on a probability of revisit of the visitor, and purchase rate information of the visitor.

Accordingly, the platform server may recommend the design of the online shop based on the characteristics of the seller group in the hierarchy of the sellers.

As described in FIGS. 3 and 4, a plurality of sellers may share the design of their online shops with each other. Although it may seem difficult to share the design of the online shop as it means sharing the design with potential competitors, when sales of the entire seller group increase due to an increase in sales of the sellers included in the seller group, the profits are distributed according to the set profit rate, which may increase the profits of all sellers included in the seller group, due to the nature of the hierarchy of the sellers described above, and thus design sharing between the sellers may be possible. And even sub-sellers (e.g. first general seller 415-1 and third general seller 415-3) who are subordinate to different upper sellers may share the design of their online shops with each other because direct or indirect compensation, such as adjusting the profit rate of the top seller (e.g., master seller 411) or changing stratums, is possible. In addition, even if the sellers (e.g., the first plurality of general sellers 415 and the second plurality of general sellers 425) are included in different sales groups, the product category may be the same (e.g., clothing), but the products may be different (e.g., sportswear and everyday clothes), and thus the sellers may share the design of the online shop with each other. In addition, since an increase in sellers in the same category may lead to an increase in the number of purchasers visiting the e-commerce platform, which may lead to an increase in overall sales volume, even different seller groups (e.g., first seller group 410 and second seller group 420) may share the design of their online shops with each other.

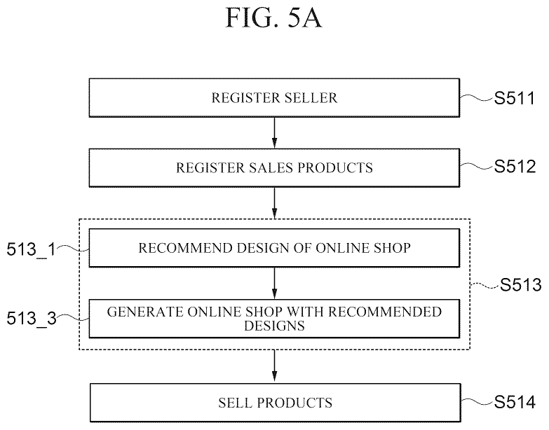

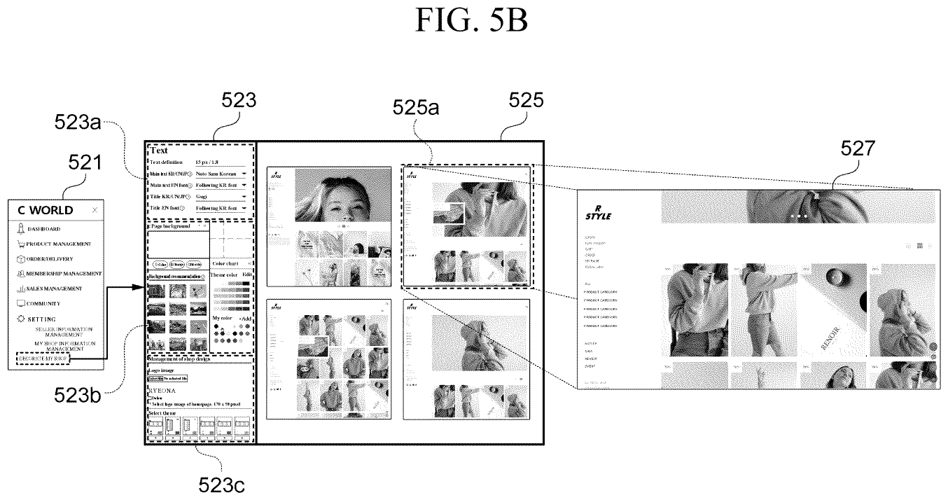

FIGS. 5A and 5B are diagrams illustrating recommending the design of the online shop in the process of generating a new online shop according to an embodiment.

Referring to FIG. 5A, the platform server (e.g., platform server 100 of FIG. 1) may recommend the design of the online shop in the process of generating the online shop of a newly registered seller.

According to one embodiment, in step S511, the platform server may register a plurality of sellers in the hierarchy consisting of an upper seller and sub-sellers subordinate to the upper seller. According to one embodiment, the platform server may register a plurality of sellers in the hierarchy. For example, the platform server may register a plurality of sellers including at least one top seller, and at least one sub-seller subordinate to each of the at least one top seller in a hierarchy corresponding to a seller group. For example, the hierarchy may include at least one seller group (e.g., seller groups 410 and 420 in FIG. 4) in which at least one subordinate sub-seller forms a stratum while being centered around the top seller. According to one embodiment, the seller group may include the master sellers (e.g., master sellers 411 and 421 of FIG. 4), a plurality of manager sellers (e.g., a plurality of manager sellers 413 and 423 of FIG. 4) respectively subordinate to the master sellers, and a plurality of general sellers (e.g., a plurality of general sellers 415 and 425 of FIG. 4) respectively subordinate to the plurality of manager sellers.

According to one embodiment, in step S512, the platform server may register the sales products of the top seller of the hierarchy. For example, the platform server may register the sales products of the top seller for each seller group. According to one embodiment, the platform server may register products in a designated category as the sales products of the top seller. For example, the platform server may register sportswear in the clothing category as the sales product.

According to one embodiment, in step S513, the platform server may generate an online shop of each of a plurality of registered sellers. For example, the generated online shop may include at least one of the sales products registered by the top seller of the seller group that includes a plurality of respective sellers.

According to one embodiment, in step S513_1, the platform server may recommend the design of the online shop. For example, the platform server may recommend a design determined based on the hierarchy. According to one embodiment, the platform server may determine the recommended design based on the design of at least one seller selected from the seller group (e.g., first seller group 410 in FIG. 4) including the seller for whom design of the online shop is recommended. The sales product of the top seller of the seller group may be, for example, sportswear in the clothing category. According to one embodiment, the platform server may determine the recommended design based on the design of at least one seller selected from a seller group (e.g., second seller group 420 of FIG. 4) of another top seller (e.g., second top seller 421 of FIG. 4) who has registered sales products in the same category as the sales products of the top seller (e.g., first top seller 411 of FIG. 4) to whom the seller, for whom design is recommended of the online shop, is subordinate. The sales product of the top seller of the other seller group may be, for example, everyday clothes of the same clothing category. According to one embodiment, the recommended design may be a design suitable for the sales products. For example, the recommended design may be a design suitable for selling sportswear.

According to one embodiment, in step S513_3, the platform server may generate an online shop to which the recommended design is applied. For example, the platform server may generate the online shop to which the recommended design is applied according to the request of the seller. For example, the generated online shop may include sales products selected by the seller who requested the generation of the online shop among the sales products of the top seller.

According to one embodiment, in step S514, the platform server may provide a product sales service to the purchaser (e.g., purchaser 320 of FIG. 3) through the generated online shop. In other words, the seller may sell products to the purchaser through the generated online shop.

Referring to FIG. 5B, the platform server may recommend the design of the online shop through a UI for generating an online shop.

According to one embodiment, the platform server may provide a total solution 521 for product sales to the registered sellers. The total solution 521 for product sales includes, for example, solutions for managing sales products, orders, delivery, refunds, etc., including setting up the online shop.

According to one embodiment, the platform server may provide a solution 523 for setting the design of the online shop. According to one embodiment, the platform server may provide a solution 523a for setting the text style of the online shop. For example, the platform server may provide the solution 523a for setting the text style to be applied to each part (e.g., body, title, etc.) of the online shop. According to one embodiment, the platform server may provide a solution 523b for setting the background of the online shop. For example, the platform server may provide the solution 523b for setting an image that can be applied to the background or a theme color. According to one embodiment, the platform server may provide a solution 523c for applying a template to the online shop. For example, the platform server may provide the solution 523c for applying the template by which a designated color theme can be uniformly applied.

According to one embodiment, the platform server may provide at least one recommended design 525. According to one embodiment, the platform server may provide the recommended design based on the design of at least one seller selected among a plurality of sellers in a seller group that includes the seller, for whom the design is recommended, or another seller group whose registered products are in the same category. The recommended design may be, for example, a design of the at least one selected seller, or a design obtained by selectively combining parts of the design. According to one embodiment, the platform server may provide the seller with a preview image of the online shop in which the selected sales product is listed in the recommended design. For example, the platform server may provide the seller with the preview image of the online shop in which sportswear, which is the sales product, is listed.

According to one embodiment, the platform server may generate an online shop 527 by applying a recommended design 525a selected by the seller. For example, the platform server may generate the online shop 527 in which sportswear, which is the selected sales product, is listed.

Accordingly, as a preliminary measure for the newly registered seller, the platform server may recommend the design of the online shop using history information of other sellers before selling products.

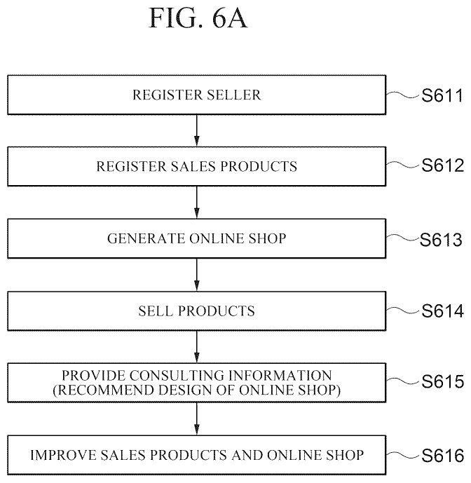

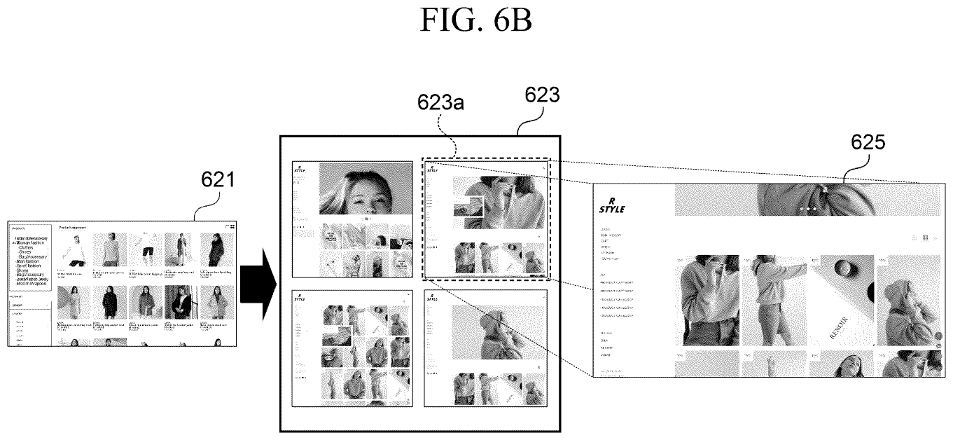

FIGS. 6A and 6B are diagrams illustrating recommending the design of the online shop in the process of providing consulting information according to an embodiment.

Referring to FIG. 6A, the platform server (e.g., platform server 100 in FIG. 1) may recommend the design of the online shop in the process of providing consulting information to an existing seller.

According to one embodiment, in step S611, similar to step S511 of FIG. 5A, the platform server may register a plurality of sellers including at least one top seller and at least one sub-seller respectively subordinate to the at least one top seller in the hierarchy corresponding to the seller group.

According to one embodiment, in step S612, similar to step S512 of FIG. 5A, the platform server may register sales products of the top seller of the hierarchy. For example, the platform server may register sportswear of the clothing category of the top seller as the sale product.

According to one embodiment, in step S613, the platform server may generate an online shop of each of a plurality of registered sellers. For example, the platform server may generate an online shop based on user input for setting the design of the online shop. The user input may be input through, for example, a solution for setting the design of the online shop (e.g., design solution 523 of FIG. 5B).

According to one embodiment, in step S614, similar to step S514 of FIG. 5A, the platform server may provide the product sales service to the purchaser (e.g., purchaser 320 of FIG. 3) through the generated online shop.

According to one embodiment, in step S615, the platform server may provide consulting information based on the history of selling products through the online shop. For example, the platform server may provide consulting information about sales products and the design of the online shop based on sales history. According to one embodiment, the platform server may recommend the design of the online shop through the consulting information. The recommended design may be determined based on the sales history of the online shop. According to one embodiment, the platform server may determine the recommended design based on the sales amount of the online shop. For example, the platform server may determine the recommended design based on the design of at least one seller whose sales amount is higher than that of the seller, for whom design is recommended, in at least one of a seller group (e.g., first seller group 410 of FIG. 4) including the seller, for whom the design is recommended and another seller group (e.g., second seller group 420 in FIG. 4) selling the product (e.g., everyday clothes in the clothing category) in the same category as the product of the seller group (e.g., sportswear in the clothing category).

According to one embodiment, in step S616, the sales products and the online shop may be improved through the consulting information provided by the platform server. According to one embodiment, the platform server may apply the recommended design to an existing online shop. For example, the platform server may apply the recommended design to the existing online shop according to the request of the seller.

According to one embodiment, the platform server may recommend the design of the online shop not only in the process of providing consulting information, but also in the process of generating the online shop. In other words, the platform server may recommend the design of the online shop once in the process of generating a new online shop, and then recommend the design of the online shop again based on sales history.

Referring to FIG. 6B, the platform server may recommend the design of the online shop through consulting information.

According to one embodiment, the platform server may store the history of selling products through an existing online shop 621. For example, the platform server may store information related to sales of the existing online shop 621. The information related to the sales may include, for example, sales amount information, member subscription rate information, information on a length of time that a visitor stays in the online shop, information on a probability of revisit of the visitor, and purchase rate information of the visitor.

According to one embodiment, the platform server may provide consulting information based on the stored sales history information. According to one embodiment, the platform server may provide at least one recommended design 623 through the consulting information. The at least one recommended design 623 may be determined based on, for example, a design of at least one seller selected from at least one of a seller group that includes the seller, for whom design was recommended, and another seller group that sells products in the same category as the products of the seller group. According to one embodiment, the selected at least one seller may be a seller whose sales amount is higher than that of the seller for whom design is recommended. According to one embodiment, the platform server may provide the seller with the preview image of the online shop in which sales products of the existing online shop 621 are listed in the recommended design. For example, the platform server may provide the seller with the preview image of the online shop in which sportswear, which is the sales product, is listed.

According to one embodiment, the platform server may apply a recommended design 623a selected by the user to the existing online shop (625). For example, the platform server may apply the selected recommended design 623a to the online shop 621 in which existing sportswear is listed (625).

Accordingly, the platform server may also recommend the design of the online shop to existing registered sellers using information on the history of product sales as a follow-up measure.

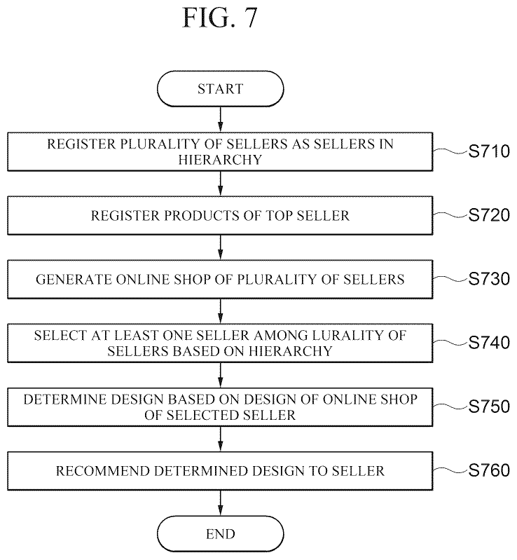

FIG. 7 is a flowchart illustrating a method for recommending the design of the online shop according to an embodiment.

According to one embodiment, in step S710, the platform server may register a plurality of sellers as sellers in the hierarchy. For example, the platform server may register a plurality of sellers including at least one top seller and at least one sub-seller respectively subordinate to the at least one top seller in the hierarchy corresponding to the seller group. For example, the hierarchy may include at least one seller group in which at least one subordinate sub-seller forms a stratum while being centered around the top seller.

According to one embodiment, in step S720, the platform server may register products of the top seller. For example, the platform server may register sales products of the top seller for each seller group.

According to one embodiment, in step S730, the platform server may generate an online shop of each of a plurality of sellers. For example, the online shop may include at least one of the registered sales products of the top seller of the seller group to whom the plurality of sellers belong.

According to one embodiment, in step S740, the platform server may select at least one seller among the plurality of sellers based on the hierarchy.

According to one embodiment, the platform server may select at least one seller among the plurality of sellers in the seller group that includes the seller for whom the design is recommended. According to one embodiment, the platform server may select the at least one seller based on the similarity of content included in the configuration of the online shop. The similarity of the content may be determined based on, for example, information about the type of products, the image of the sales products, and the text description of the sales products. According to one embodiment, the platform server may select the at least one seller whose rank is higher than or equal to a designated rank based on information related to sales of the online shop. The information related to the sales may include, for example, sales amount information, member subscription rate information, information on a length of time that a visitor stays in the online shop, information on a probability of revisit of the visitor, and purchase rate information of the visitor. According to one embodiment, the platform server may select the at least one seller among sub-sellers included in the seller group. For example, the platform server may register the plurality of sellers as a master seller who is a top seller, manager sellers subordinate to the master seller, and general sellers subordinate to the manager sellers, and select the at least one seller among the registered general sellers.

According to one embodiment, in step S750, the platform server may determine a design to be recommended to the seller based on the design of the online shop of the selected seller. For example, the platform server may determine the design of the online shop of the selected seller as the recommended at least one design. For another example, the platform server may determine a new design obtained by selectively combining parts of the design of the online shop of the selected at least one seller as the recommended at least one design.

According to one embodiment, in step S760, the platform server may recommend the determined design to the seller. For example, in step S730, the platform server may recommend the determined at least one design to the seller who requested generation of the online shop in the process of generating the online shop. For another example, the platform server may recommend the determined at least one design to the seller in the process of providing consulting information based on information on the history of product sales through the online shop generated in step S730. According to one embodiment, when recommending the design of the online shop through consulting information provided based on the sales history information, the platform server may select at least one seller whose sales amount is higher than that of the seller from at least one of a seller group that includes the seller, for whom design is recommended, and another seller group that sells products in the same category as the sales products of the seller group, and determine the recommended design based on the design of the selected seller.

According to one embodiment, steps S710 to S760 may be implemented by a computer program stored in a computer-readable storage medium and configured to be executed by one or more processors. The computer program may include an instruction set in which steps S710 to S760 are implemented in a programming language.

The e-commerce platform service provided through the platform server 100 according to various embodiments described in FIGS. 1 to 7 allows the supplier, the seller, and the content creator for distributing and selling products to come together in one platform service, and thus they can easily find experts outside their own field and cooperate with each other to sell the products. In addition, the e-commerce platform service can reduce the risks that users who cooperate in selling the products should bear when they sell the products on their own, allow the users to focus on their respective fields of expertise and do their best, and further promote product sales by distributing sales profits according to a proportion of contribution to products sales of the users, thereby increasing each person's profits and creating a virtuous cycle structure in which each person develops in his/her field. In addition, this virtuous cycle structure of the e-commerce platform service can prevent damage to the suppliers and the sellers due to competition for the lowest price in the existing open market, and form a healthy market that provides purchasers with high-quality products at reasonable prices.

In addition, the e-commerce platform service of the platform server 100 creates an environment in which the plurality of sellers can share the design of their online shops with each other by registering the plurality of sellers in the hierarchy where an increase in sales of members can lead to an increase in profits for the entire seller group, and determines the recommended design based on information of the seller in the created environment, thereby capable of recommending the design of online shop, that is suitable for sales products and actively reflect current sales trends that can directly affect sales compared to uniformly recommending the pre-made design of online shop according to the designated category, to the seller.

According to embodiments disclosed herein, the e-commerce platform service provided through the platform server allows the supplier, the seller, and the content creator for distributing and selling products to come together in one platform service, and thus they can easily find experts outside their own field and cooperate with each other to sell the products. In addition, the e-commerce platform service can reduce the risks that users who cooperate in selling the products should bear when they sell the products on their own, allow the users to focus on their respective fields of expertise and do their best, and further promote product sales by distributing sales profits according to a proportion of contribution to products sales of the users, thereby increasing each person's profits and creating a virtuous cycle structure in which each person develops in his/her field. In addition, this virtuous cycle structure of the e-commerce platform service can prevent damage to the suppliers and the sellers due to competition for the lowest price in the existing open market, and form a healthy market that provides purchasers with high-quality products at reasonable prices.

What is claimed is:

1. An e-commerce platform server comprising:
a communication device;
a memory configured to store one or more instructions; and
a processor configured to execute the one or more instructions stored in the memory, wherein the processor is configured, by executing the one or more instructions, to:
register a plurality of sellers including at least one top seller and at least one sub-seller subordinate to each of the at least one top seller in a seller database (DB) in a hierarchy corresponding to a seller group, the at least one subordinate sub-seller while being centered around the top seller forming a stratums of the hierarchy in the seller group, the sub-seller being subordinate to the top seller to whom the sub-seller subordinates in terms of sales products and sales conditions of products, and the plurality of sellers included in the seller group sharing profits from product sales according to a profit rate set by the top seller;
register sales products of the top seller for each seller group in a sales products DB;
generate an online shop of each of the plurality of sellers, the online shop including at least one of registered sales products of the top seller of the seller group to whom the plurality of sellers belong;
select at least one seller among a plurality of sellers of the seller group including a designated seller and the seller group of another top seller who has registered products in the same category as sales products of the top seller to whom the designated seller is subordinate;
determine at least one design based on a design of the online shop of the selected at least one seller; and
recommend the determined at least one design to the seller.

2. The e-commerce platform server of claim 1, wherein the processor is further configured, by executing the one or more instructions, to:
select the at least one seller based on similarity of content included in a configuration of the online shop when selecting at least one seller from the seller group of the seller for whom the design is recommended.

3. The e-commerce platform server of claim 2, wherein the similarity of the content is determined based on information about a type of sales products, an image of the sales products, and a text description of the sales products.

4. The e-commerce platform server of claim 1, wherein the processor is further configured, by executing the one or more instructions, to select the at least one seller whose rank is higher than or equal to a designated rank based on information related to sales of the online shop when selecting at least one seller from the seller group of the seller for whom the design is recommended.

5. The e-commerce platform server of claim 4, wherein the information related to the sales of the online shop includes sales amount information, member subscription rate information, information on a length of time that a visitor stays in the online shop, information on a probability of revisit of the visitor, and purchase rate information of the visitor.

6. The e-commerce platform server of claim 1, wherein the processor is further configured, by executing the one or more instructions, to select the at least one seller among sub-sellers included in the seller group when selecting at least one seller from the seller group of the seller for whom the design is recommended.

7. The e-commerce platform server of claim 6, wherein the processor is further configured, by executing the one or more instructions, to:
register the top seller as a master seller in the seller DB, register sub-sellers subordinate to the top seller as manager sellers and general sellers subordinate to the manager seller in the seller DB, when registering the plurality of sellers in the hierarchy, the manager seller being granted an authority to manage the general sellers; and
select the at least one seller among the general sellers when selecting at least one seller among the sub-sellers.

8. The e-commerce platform server of claim 1, wherein the processor is further configured to, by executing the one or more instructions, determine the design of the online shop of the selected at least one seller as the recommended at least one design when determining the at least one design.

9. The e-commerce platform server of claim 1, wherein the processor is further configured to, by executing the one or more instructions, determine a new design obtained by selectively combining parts of the design of the online shop of the selected at least one seller as the recommended at least one design, when determining the at least one design.

10. The e-commerce platform server of claim 1, wherein the processor is further configured to, by executing the one or more instructions, recommend the determined at least one design to the seller who requested generation of the online shop in a process of generating the online shop, when recommending the determined at least one design to the seller.

11. The e-commerce platform server of claim 1, wherein the processor is further configured, by executing the one or more instructions, to:
recommend the determined at least one design to the seller in a process of providing consulting information based on history information on selling products through the generated online shop, when recommending the determined at least one design to the seller; and
select the at least one seller whose sales amount is higher than that of the seller for whom the design is recommended among at least one of a seller group that includes the seller for whom the design is recommended and another seller group that sells products in the same category as sales products of the seller group, when selecting at least one seller among the plurality of sellers.

12. A method for operating a server that provides an e-commerce platform service, the method comprising:
registering a plurality of sellers including at least one top seller and at least one sub-seller subordinate to each of the at least one top seller in a seller database (DB) in a hierarchy corresponding to a seller group, at least one sub-seller subordinate to the top seller forming a stratums of a hierarchy in the seller group, the sub-seller being subordinate to the top seller to whom the sub-seller subordinates in terms of sales products and sales conditions of products, and the plurality of sellers included in the seller group sharing profits from product sales according to a profit rate set by the top seller;
registering sales products of the top seller for each seller group in a sales products DB;
generating an online shop for each of the plurality of sellers, the online shop including at least one of registered sales products of the top seller of the seller group to whom the plurality of sellers belong;
selecting at least one seller among a plurality of sellers the seller group including a designated seller and the seller group of another top seller who has registered products in the same category as sales products of the top seller to whom the designated seller is subordinate;
determining at least one design based on a design of the online shop of the selected at least one seller; and
recommending the determined at least one design to the seller.

13. A computer program stored in a computer-readable storage medium and configured to be executed by one or more processors in order to execute an operation method of a server providing an e-commerce platform service, the computer program including:
an instruction for registering a plurality of sellers including at least one top seller and at least one sub-seller subordinate to each of the at least one top seller in a seller database (DB) in a hierarchy corresponding to a seller group, at least one sub-seller subordinate to the top seller forming a stratums of a hierarchy in the seller group, the sub-seller being subordinate to the top seller to whom the sub-seller subordinates in terms of sales products sold and sales conditions of products, and the plurality of sellers included in the seller group sharing profits from product sales according to a profit rate set by the top seller;
an instruction for registering sales products of the top seller for each seller group in a sales products DB;
an instruction for generating an online shop for each of the plurality of sellers, the online shop including at least one of registered sales products of the top seller of the seller group to whom the plurality of sellers belong;
an instruction for selecting at least one seller among a plurality of sellers of the seller group including a designated seller and the seller group of another top seller who has registered products in the same category as sales products of the top seller to whom the designated seller is subordinate;
an instruction for determining at least one design based on a design of the online shop of the selected at least one seller; and
an instruction for recommending the determined at least one design to the seller.
